(19) United States
(12) Patent Application Publication
(10) Pub. No.: US 2015/0204115 A1
(43) Pub. Date: Jul. 23, 2015

(54) LATCH HOUSING WITH STRENGTHENING FEATURE

(71) Applicants: Kurt E. Nurmi, Macomb, MI (US); Carlos Tostado, Ciudad Juarez (MX); Rogelio Terrazas, Ciudad Juarez (MX); Donald M. Perkins, Sterling Heights, MI (US)

(72) Inventors: Kurt E. Nurmi, Macomb, MI (US); Carlos Tostado, Ciudad Juarez (MX); Rogelio Terrazas, Ciudad Juarez (MX); Donald M. Perkins, Sterling Heights, MI (US)

(21) Appl. No.: 14/598,859

(22) Filed: Jan. 16, 2015

Related U.S. Application Data
(60) Provisional application No. 61/928,642, filed on Jan. 17, 2014.
(60) Provisional application No. 61/928,675, filed on Jan. 17, 2014.

(51) Int. Cl. E05B 85/02

(52) U.S. Cl. CPC E05B 85/02

(57) ABSTRACT

A housing for a latch is provided, the housing having a strengthening feature. A vehicle door latch is provided. The vehicle door latch having: a housing having an integrally formed strengthening feature located in an exterior wall of the housing; a bumper located adjacent to an interior surface of the wall having the strengthening feature; a fork bolt rotabably mounted to the housing for movement into a closed position wherein a portion of the fork bolt contacts the bumper and applies a load to the strengthening feature of the housing.

### CROSS REFERENCE TO RELATED APPLICATIONS

This application claims the benefit of U.S. Provisional Patent Application Ser. No. 61/928,642 filed on Jan. 17, 2014, the entire contents of which are incorporated herein by reference thereto.

This application also claims the benefit of U.S. Provisional Patent Application Ser. No. 61/928,675 filed on Jan. 17, 2014, the entire contents of which are incorporated herein by reference thereto.

### BACKGROUND

Various embodiments of the present invention relate to a housing for a latch and more particularly, a latch housing with a strengthening feature.

In some applications, the latch housing is subject to forces as a fork bolt of the latch rotates.

Accordingly, it is desirable to provide a latch housing with a strengthening feature.

### SUMMARY OF THE INVENTION

In one embodiment, a housing for a latch is provided, the housing having a strengthening feature.

In another embodiment, the strengthening feature is a plurality of ribs.

In yet another embodiment, a vehicle door latch is provided. The vehicle door latch having: a housing having an integrally formed strengthening feature located in an exterior wall of the housing; a bumper located adjacent to an interior surface of the wall having the strengthening feature; a fork bolt rotabably mounted to the housing for movement into a closed position wherein a portion of the fork bolt contacts the bumper and applies a load to the strengthening feature of the housing.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a top view of a latch housing wherein the strengthening feature is shown in phantom;

FIGS. 2 and 2A are side perspective views of the latch housing illustrating the strengthening feature;

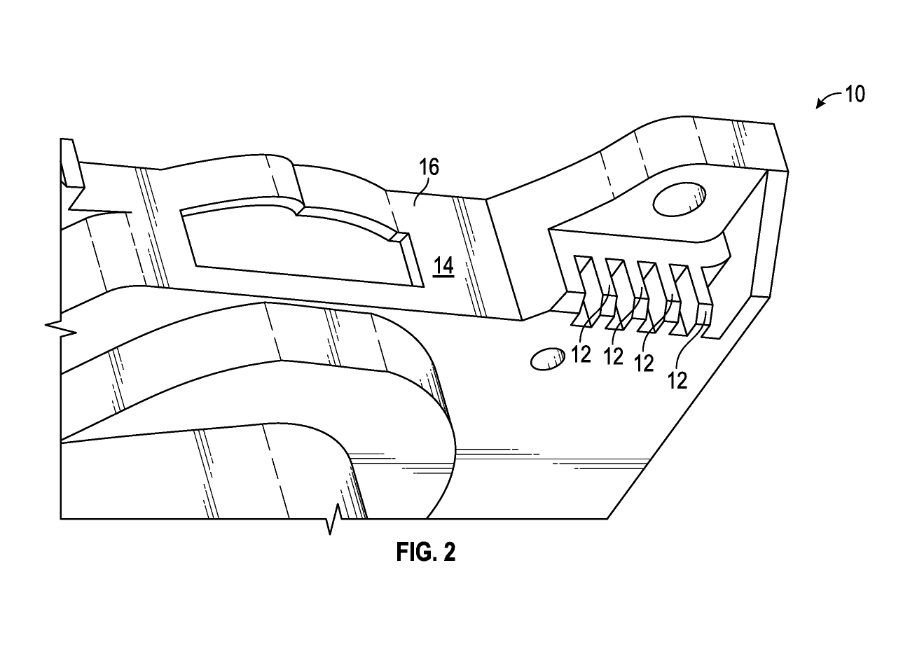

FIG. 3 a top view of the latch housing; and

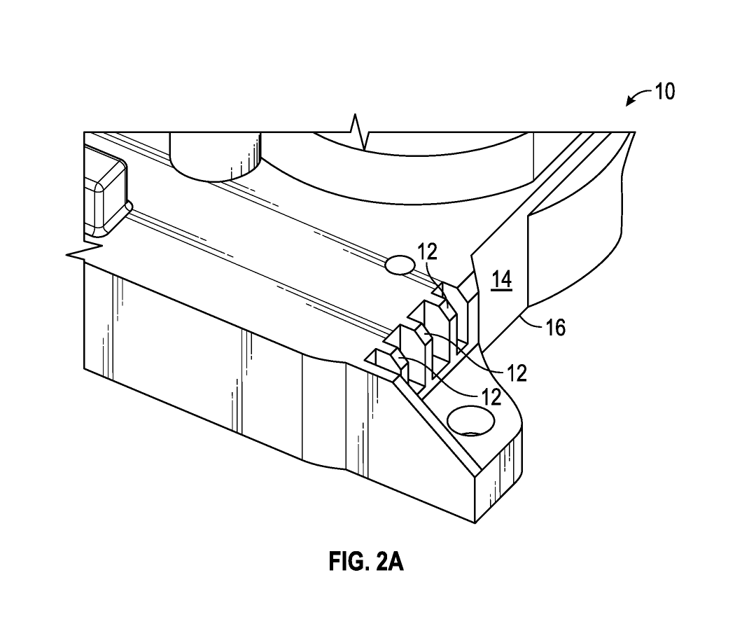

FIG. 4 is a top view of the latch housing illustrating a fork bolt and detent lever, wherein the fork bolt has contacted the bumper;

FIG. 4A view of the latch housing illustrating the fork bolt in an open position; and

FIG. 5 is bottom view of the latch housing.

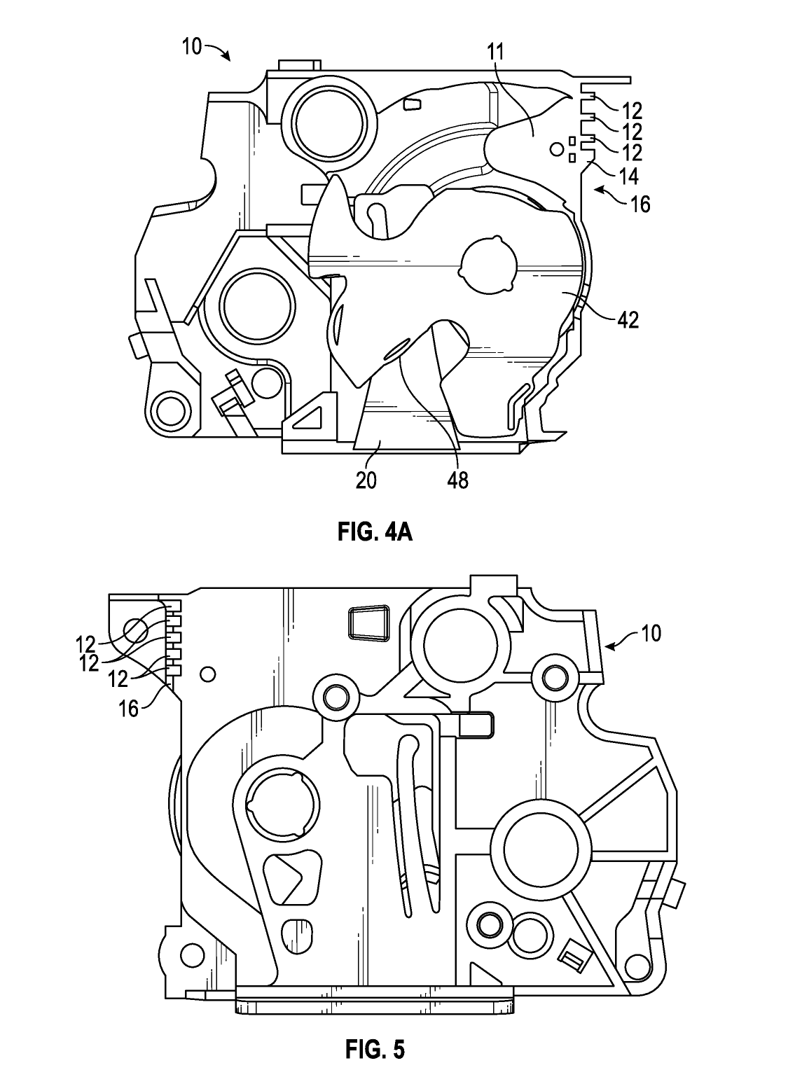

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

Reference is made to the following U.S. Pat. Nos. 3,969,789; 6,568,741; 6,679,531; 8,348,310 and U.S. Patent Publication Nos. US 2010/0127512; US 2011/0204659; US 2012/0292927 and US 2014/0292000, the entire contents each of which are incorporated herein by reference thereto.

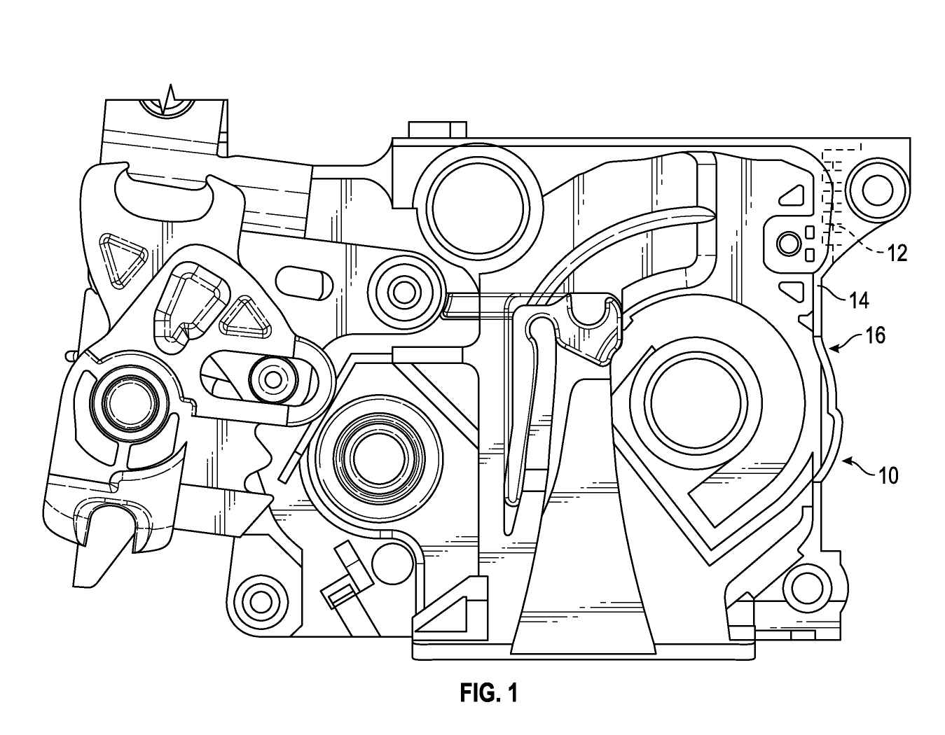

Referring now to the FIGS. and in particular, FIG. 1 a latch housing 10 is illustrated. In one embodiment, the latch housing 10 is used with or comprises a portion of a vehicle door latch or in any other vehicle latch. Latch housing 10 may be formed from an easily molded material such a plastic or any suitable polymer. Alternatively, latch housing 10 may be formed from a metal or metal alloy of combinations of metal, metal alloys and plastic. Housing 10 may comprise a lower housing portion and an upper housing portion (e.g., a housing having two or more portions secured together to form the housing when latch is assembled).

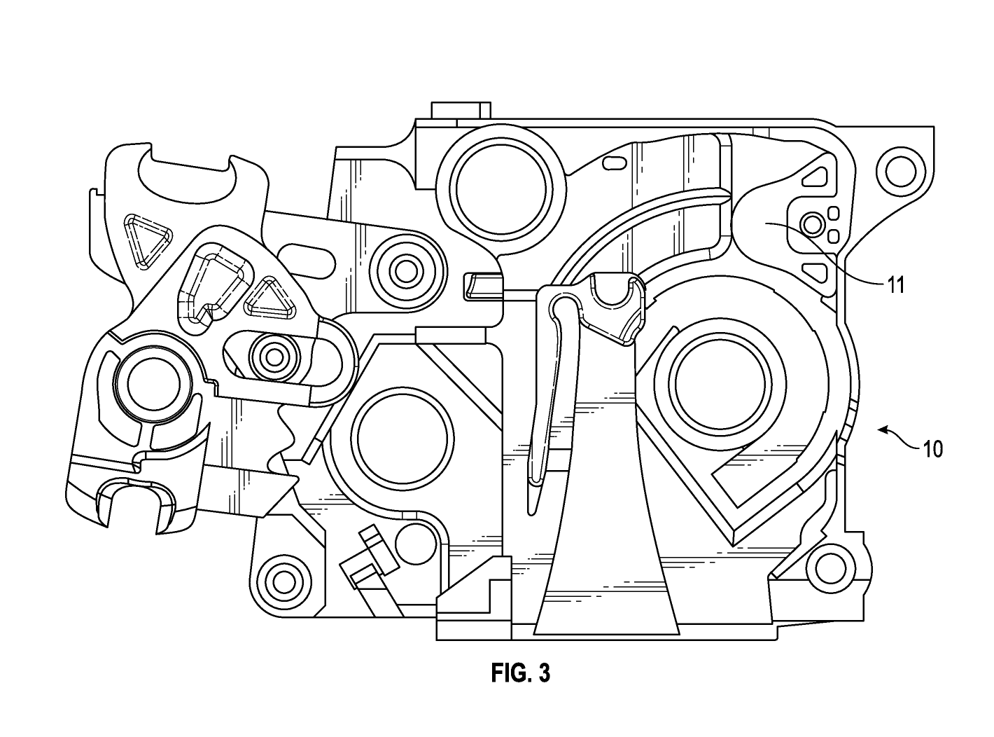

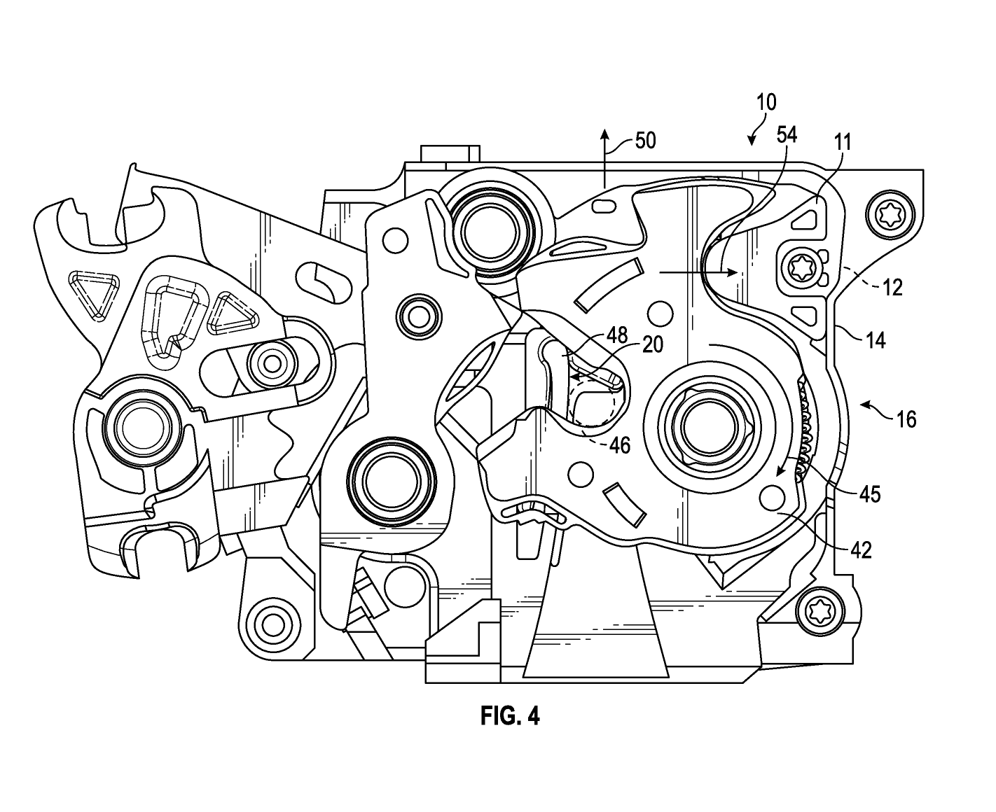

In some assemblies when a claw or fork bolt 42 of a latch rotates or moves to a certain position the housing 10 may be subject to a load. In some embodiments, this is due to the fork bolt or claw contacting a bumper 11 located between the housing wall and the moving or rotating fork bolt as it transitions through various stages of rotation. In one embodiment, the bumper 11 may be located adjacent to or proximate to an interior surface of the wall and the strengthening features are located on an opposite exterior surface of the wall. In one embodiment, the loads may be applied in the direction of arrow 54 as the fork bolt 42 rotates in the direction of arrow 45 to the closed or latched position illustrated in FIG. 4 from the open position illustrated in FIG. 4A, which may be due to a striker 46 traveling in the direction of arrow 50 as the fork bolt or claw 42 rotates into a closed or latched position. As is known in the related arts this may be due to the striker 46 being received in a throat 20 of the housing 10 and a throat 48 of the fork bolt or claw 42.

In order to accommodate for this load the structural integrity of the latch housing is increased by locating a strengthening feature proximate to the desired area of increased strength. In one embodiment, the strengthening feature may be integrally formed or molded with housing as it is formed during any suitable manufacturing process (e.g., injection molding, 3D printing and equivalents thereof).

In one embodiment, this strengthening feature is provided by a plurality of ribs 12 located on an exterior surface 14 of a wall 16 of the latch housing 10. Ribs may be vertically arranged and may be located to provide discrete areas of increased wall thickness adjacent to bumper 11.

The addition of vertical structural features and optimized wall thickness provides a latch housing geometry that can withstand forces applied to it via the fork bolt or claw 42 and in particular if the fork bolt or claw has rotated to an over travel position in the direction of arrow 45 thereby applying a load in the direction of arrow 54.

In one embodiment and by optimizing the existing latch assembly or latch housing geometry, an improved latch and/or latch housing is provided. Moreover, this improved design is facilitated through no additional components as the strengthening feature is incorporated into the existing housing. Thereby saving piece cost as well as tooling costs. Still further and in one embodiment and by incorporating these features into the existing housing there is no requirement to change the tooling or fixtures required for the manufacture of the housing.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A housing for a latch, wherein the housing has a strengthening feature.

2. The housing as in claim 1, wherein the strengthening feature is a plurality of ribs located on an exterior of the housing.

3. The hosing as in claim 2, wherein the plurality of ribs are integrally molded into the housing and the housing is formed from plastic.

4. The housing as in claim 3, wherein the plurality of ribs are adjacent to a wall of the housing that receives an impact force from a fork bolt of the latch.

5. The housing as in claim 4, wherein the latch is a vehicle door latch.

6. The housing as in claim 4, wherein the plurality of ribs are adjacent to a wall that has a bumper positioned to receive an impact when a fork bolt of the latch has reached a closed position.

7. The housing as in claim 4, wherein the plurality of ribs are adjacent to a wall that has a bumper positioned to receive an impact when a fork bolt of the latch has travelled past a closed position.

8. A vehicle door latch, comprising:
a housing having an integrally formed strengthening feature located in an exterior wall of the housing;
a bumper located adjacent to an interior surface of the wall having the strengthening feature; and
a fork bolt rotabably mounted to the housing for movement into a closed position wherein a portion of the fork bolt contacts the bumper and applies a load to the strengthening feature of the housing.

9. The vehicle door latch as in claim 8, wherein the strengthening feature is a plurality of vertically arranged ribs.

10. The vehicle door latch as in claim 9, wherein the housing is formed form plastic.

11. The vehicle door latch as in claim 10, wherein the strengthening feature is a plurality of vertically arranged ribs.
